(19) United States
(12) Patent Application Publication
(10) Pub. No.: US 2013/0036020 A1
(43) Pub. Date: Feb. 7, 2013

(54) Computerized method and system for conducting an auction on the internet

(71) Applicants: Robert R. Kieser, Plymouth, MN (US); Eunice F. Kieser, Plymouth, MN (US)

(72) Inventors: Robert R. Kieser, Plymouth, MN (US); Eunice F. Kieser, Plymouth, MN (US)

(21) Appl. No.: 13/563,235

(22) Filed: Jul. 31, 2012

Related U.S. Application Data
(60) Provisional application No. 61/514,359, filed on Aug. 2, 2011.

(51) Int. Cl. G06Q 30/08

(52) U.S. Cl. 705/26.3

(57) ABSTRACT

A method and system for conducting an auction on the internet whereby a participant is required to establish an account for bidding on auction items that are listed for bid for a time period of one hour. All items listed on the site are displayed with a countdown timer. Items are only up for auction and open for bidding for a period of one hour commencing when the countdown timer displays sixty minutes (60 min.) remaining. A user may initiate a live auction by selecting an item that has a countdown timer displaying a time greater than one-hundred-twenty minutes (120 min.). A user may only initiate one live auction during a sixty minute period. If an auction is won, a user must pay for the item promptly or lose their bidding privileges.

### CROSS REFERENCE TO RELATED APPLICATIONS

This application claims priority to U.S. Provisional Patent Application No. 61/514, 359 titled Computerized method and system for conducting an auction on the internet filed Aug. 2, 2011 to the above named inventors.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to a method and system of conducting an auction on the internet whereby auctions for individual items last for a period of one hour, an individual is required to pay for all auction items won or lose their bidding privileges, and only auction items with an auction start time greater than one hundred twenty minutes (120 min.) are allowed to be initiated. Several auction systems and methods appear in the prior art, however these systems and methods do not ensure that the individual with the winning bid must pay for the item within one (1) hour or lose their bidding privileges, they do not have auctions in specific categories that last only one hour, and they do not allow a user to start their own auction for items listed and not currently being auctioned.

### SUMMARY OF THE INVENTION

This present invention is directed to method and system of conducting an auction online using a computer. The computer includes a means of connecting to the internet and access a given website hosted on a server. The computer may be connected to the internet using various means such as wireless using an internet router or hardwired using an Ethernet cable. According to one embodiment of the present invention, a participant will use a computer and web browsing software to access the internet and enter a web address corresponding to the home page where the auction will occur. Through this webpage, the participant will then access the auction program hosted on a server. This server has installed software to manage a participant's interactions with the auction website. This home page can also be accessed via the participant's mobile phone or tablet, using either a browser or an installed application.

Upon arriving at the home page, the participant can freely browse the website and look at items to bid on. These items may be any number and type of item including consumer products, personal and home electronics, household goods, sporting goods, books, cameras and camera equipment, outdoor clothing and accessories, health and beauty supplies, home décor, home and garden supplies, hunting supplies, camping supplies, baby items, jewelry, clothing, music, office equipment and supplies, pet supplies, toys, video games and systems, computer's and accessories, crafts, movies, fragrances, or any other similar good or item. These goods may be auctioned for any amount, with the preferred amount being twenty-five (25%) to fifty percent (50%) off of the manufacturer's suggested retail price.

If a participant would like to bid on an item, they must first register, if they have not done so on a previous visit. At registration, the participant will be required to provide their name, address, telephone number, email address, and create a unique username and password. In addition, a participant registering may create a unique security identifier to allow the participant access to their account in the event of a forgotten password.

The participant is then directed to a terms of use display and an acknowledgement of the auction rules display where they are required to acknowledge an understanding of the auction rules and the terms of use of the website. A failure to acknowledge these terms and conditions will result in the user having to register again and consent to the terms. These auction rules provide information about the auction features including that all auctions will close within one hour of the start time and all participants must pay for items promptly or lose their bidding privileges.

After creating an account and consenting to the terms, conditions, and auction rules, a participant may bid on items. A participate may bid on items using two separate actions, browsing or searching for items in existing live auctions, and browsing or searching for items not listed in an existing live auction and initiating an auction. When browsing the live auctions, the participant will see items that are currently being auctioned. Displayed with these live auctioned items will be the time remaining in the auction, the starting bid amount, and various pertinent details about the item up for auction. Displayed along with the item information will be a “bid now” button. A participant will then navigate to this button using a mouse, keyboard, or similar navigation device and click on the button using the corresponding device. A participant will then have the option of specifying the bid amount, with the bid being required to increase the item price by at least one percent (1%) of the starting bid price.

For an item to be listed in a live auction, the time remaining for bidding on the item must be sixty minutes (60 min.) or less. Accordingly, all items listed for bidding and displayed for browsing on the website have a countdown timer associated with them. When this timer reaches sixty minutes remaining, the item is then labeled a live auction item and the item will be auctioned off in a period of one (1) hour. If the countdown timer ends before a bid is made, the item is removed from the live auction and returned to the item inventory and the countdown timer reset.

In addition to browsing the live auctions, a participant may start an auction by searching for several listed and categorized goods listed on the website and not currently in a live auction. When items are displayed, the participant will see the item details including but limited to the starting bid price of the item, a description of the good, and a countdown timer. If there is more than one-hundred-twenty (120 min.) remaining on the countdown timer, a “Start An Auction” button is displayed. An item with a “Start An Auction” button displayed may be moved into a live auction by the participant. Accordingly, to create a live auction, a participant will navigate to this button using a mouse, keyboard, or similar navigation device and click on the button using the corresponding device.

A participant may only have one (1) initiated live auction running at a time. So, a participant cannot have concurrently running live auctions that they have initiated. To verify this, the user's identification account will be used to verify that there are no currently running user initiated live auctions at the time of clicking the “Start An Auction” button. If a user has a currently running user initiated live auction, the user will be unable to create a live auction. At this step a user may be prompted explaining the auction rules and encouraging them to bid on items in the live auction category. If the user does not have a currently running user initiated auction, the user may create a live auction by clicking on the “Start An Auction” button and starting a live auction. A participant will then have the option of specifying a bid amount higher than the starting bid listed in the item description or starting the auction at the starting bid price.

After the bid is placed, the item will be moved to the live auction section of the website and the time remaining on the auction will begin to countdown from one (1) hour with the auction ending when no time remains.

If the participant is the winning bidder, they will be required to pay for the auction item within one (1) hour. If the participant is not the winning bidder, they will not receive the item. The participant is required to pay for the item within one (1) hour as determined by the terms of use indicated at the initiation of the user's account. If the item is paid for within one (1) hour, the item will be scheduled for shipment. If the item is not paid for within one (1) hour, as determined by the terms of use, the participant will be given a strike. If the participant has three strikes, the participant will have their bidding privileges revoked. The website will have the ability to log the IP address of the computers accessing the website to prevent unauthorized access of participants who have had their bidding privileges revoked. If a participant does not have a total of three (3) strikes, but has one (1) or two (2) strikes they will be warned that future violations may subject them to the loss of bidding privileges.

In addition to participants of the auction, sellers may have their goods listed on website. To have a good listed on the website, a seller must register. During this registration process, sellers will be required to provide pertinent information related to the goods offered for sale and provide information about their business. It is preferred that all sellers be a wholesaler, have all of the proper business documentation, including but not limited to Federal Tax ID numbers and appropriate state licenses.

Additionally, it is preferred, that all sellers have a return policy approved by the website, allowing items to be returned according to website policies and that all sellers have been in business for over a year. Additionally, all sellers selling goods on the website will be required to provide reliable contact information including but not limited to their name, address, phone number, contact person, email address, and other identifying characteristics. Only sellers that are have met the approval of website, will be allowed have their items listed and displayed. Throughout this specification the terms participant and user are used, these terms are synonymous with each other, meaning a user can be a participant and a participant can be a user.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1a shows a schematic of the overall auction process having a computer 10, according to the present invention.

FIG. 1b is a continuation of the schematic block diagram of the auction process, according to the present invention.

### DETAILED DESCRIPTION OF THE INVENTION

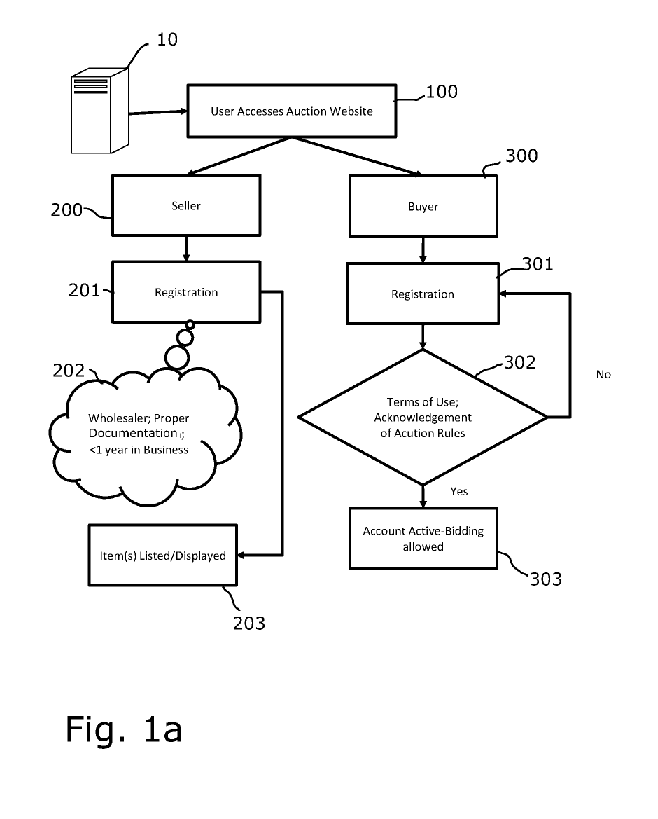

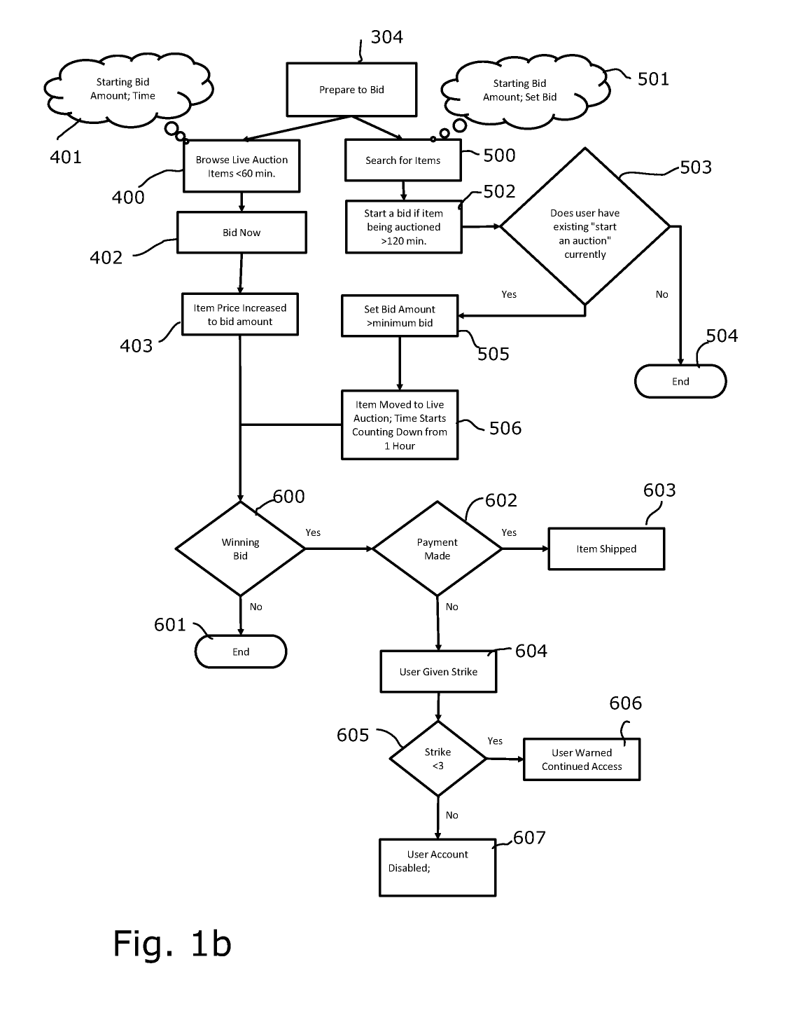

Referring now to FIG. 1a and FIG. 1b, a schematic of the overall system and method of conducting an auction online using a computer, according to the present invention, there is shown a computer 10. The computer 10 includes a means of connecting the computer 10 to the internet. This connection may be wireless using an internet router or hardwired using an Ethernet cable. According to one embodiment of the present invention, a participant will use the computer and web browsing software to access the internet and enter a web address corresponding to the home page where the auction will occur 100. Through this webpage, the participant will then access the auction program hosted on a server. This server has installed software to manage a participant's interactions with the auction website. This home page can also be accessed via the participant's mobile phone or tablet, using either a browser or an installed application.

Upon arriving at the home page, the participant can freely browse the website and look at items to bid on. These items may be any number and type of item including consumer products, personal and home electronics, household goods, sporting goods, books, cameras and camera equipment, outdoor clothing and accessories, health and beauty supplies, home décor, home and garden supplies, hunting supplies, camping supplies, baby items, jewelry, clothing, music, office equipment and supplies, pet supplies, toys, video games and systems, computer's and accessories, crafts, movies, fragrances, or any other similar good or item. These goods may be auctioned for any amount, with the preferred amount being twenty-five (25%) to fifty percent (50%) off of the manufacturer's suggested retail price.

If a participant would like to bid on an item 300, they must first register 301, if they have not done so on a previous visit. At registration 301, the participant will be required to provide their name, address, telephone number, email address, and create a unique username and password. In addition, a participant registering may create a unique security identifier to allow the participant access to their account in the event of a forgotten password.

The participant is then directed to a terms of use display and an acknowledgement of the auction rules display 302 where they are required to acknowledge an understanding of the auction rules and the terms of use of the website. A failure to acknowledge these terms and conditions 302 will result in the user having to register again and consent to the terms. These auction rules provide information about the auction features including that all auctions will close within one hour of the start time and all participants must pay for items promptly or lose their bidding privileges.

After creating an account and consenting to the terms, conditions, and auction rules, a participant may bid on items 303. A participate may bid 304 on items using two separate actions, browsing or searching for items in existing live auctions 400, and browsing or searching for items not listed in an existing live auction and initiating an auction 500. When browsing the live auctions 400, the participant will see items that are currently being auctioned. Displayed with these live auctioned items will be the time remaining in the auction, the starting bid amount 401, and various pertinent details about the item up for auction. Displayed along with the item information will be a “bid now” button 402. A participant will then navigate to this button using a mouse, keyboard, or similar navigation device and click on the button using the corresponding device. A participant will then have the option of specifying the bid amount, with the bid being required to increase the item price by at least one percent (1%) of the starting bid price 403.

For an item to be listed in a live auction 400, the time remaining for bidding on the item must be sixty minutes (60 min.) or less. Accordingly, all items listed for bidding and displayed for browsing on the website have a countdown timer associated with them. When this timer reaches sixty minutes remaining, the item is then labeled a live auction item 400 and the item will be auctioned off in a period of one (1) hour. If the countdown timer ends before a bid is made the item is removed from the live auction and returned to the item inventory and the countdown timer reset.

In addition to browsing the live auctions 400, a participant may start an auction by searching for several listed and categorized goods 500 listed on website 100 and not currently in a live auction. When items are displayed, the participant will see the item details including but limited to the starting bid price of the item, a description of the good, and a countdown timer 501. If there is more than one-hundred-twenty (120 min.) remaining on the countdown timer, a “Start An Auction” button 502 is displayed. An item with a “Start An Auction” button displayed may be moved into a live auction 400 by the participant. Accordingly, to create a live auction, a participant will navigate to this button using a mouse, keyboard, or similar navigation device and click on the button using the corresponding device.

A participant may only have one (1) initiated live auction running at a time. So, a participant cannot have concurrently running live auctions that they have initiated. To verify this, the user's identification account will be used to verify that there are no currently running user initiated live auctions at the time of clicking the “Start An Auction” button 503. If a user has a currently running user initiated live auction 500, the user will be unable to create a live auction 504. At this step a user may be prompted explaining the auction rules and encouraging them to bid on items in the live auction category. If the user does not have a currently running user initiated live auction, the user may create a live auction by clicking on the “Start An Auction” button and starting a live auction 505. A participant will then have the option of specifying a bid amount higher than the starting bid listed in the item description or starting the auction at the starting bid price 505.

After the bid is placed 505, the item will be moved to the live auction section of the website and the time remaining on the auction will begin to countdown from one (1) hour 506 with the auction ending when no time remains.

If the participant is the winning bidder 600, they will be required to pay for the auction item within one (1) hour. If the participant is not the winning bidder, they will not receive the item 601. The participant is required to pay for the item within one (1) hour, as determined by the terms of use indicated at the initiation of the user's account 602. If the item is paid for within one (1) hour, the item will be scheduled for shipment 603. If the item is not paid for within one (1) hour, as determined by the terms of use, the participant will be given a strike 604. If the participant has three (3) strikes 605, the participant will be have their bidding privileges revoked 607. The website 100 has the ability to log the IP address of computers to prevent unauthorized access of participants who have had their bidding privileges revoked. If a participant does not have a total of three (3) strikes, but has one (1) or two (2) strikes they will be warned that future violations may subject them to the loss of bidding privileges 606.

In addition to participants of the auction, sellers 200 may have their goods listed on website 100. To have a good listed on the website 100, a seller 200 must register 201. During this registration process, sellers 200 will be required to provide pertinent information related to the goods offered for sale and provide information about their business 202. It is preferred that all sellers be a wholesaler, have all of the proper business documentation, including but not limited to Federal Tax ID numbers and appropriate state licenses 202.

Additionally, it is preferred, that all sellers have a return policy approved by the website, allowing items to be returned according to website policies and that all sellers have been in business for over a year. Additionally, all sellers selling goods on the website 100 will be required to provide reliable contact information including but not limited to their name, address, phone number, contact person, email address, and other identifying characteristics. Only sellers that have met the approval of website 100, will be allowed have their items listed and displayed 203. Throughout this specification the terms participant and user are used, these terms are synonymous with each other, meaning a user can be a participant and a participant can be a user.

1. A computer implemented method for conducting an auction of wholesale products on the internet, the method comprising:
(a) a computer connected to the internet;
(b) a auction hosted on a server and accessible via the internet and displayed as a webpage;
(c) the webpage requiring a user to create a distinct and unique user account prior to bidding;
(d) items listed for sale, the items displayed on the webpage and searchable;
(e) a separate and distinct countdown timer associated with each item;
(f) moving the items to a live auction when the countdown timer reaches sixty (60) minutes remaining;
(g) allowing the user to bid on items in a live auction;
(h) allowing the user to start a live auction for an item with a countdown timer displaying a time greater than one-hundred-twenty (120) minutes;
(i) only allowing the user to start one live auction during a one (1) hour time period;
(j) awarding the item to the highest bidder when the countdown timer reaches zero;
(k) resetting the countdown timer of an item to a predetermined amount, if the item has not been bid on;
(l) requiring the user to pay for the item within one hour of receiving the winning bid;
(m) if an item is not paid for within the one hour allotted time; the user is given a strike;
(n) the accumulation of three strikes by the user will result in the loss of bidding privileges; and
(o) shipping the item to the user with the winning bid after payment is processed.

2. A system and method for conducting an auction of wholesale products on the internet using a user computer accessible to a computer hosting an auction website containing the auction parameters, the system and method comprising:
(a) requiring the user to create a distinct and unique user account prior to bidding;
(b) items listed for sale, the items displayed on the webpage and searchable;
(c) a separate and distinct countdown timer associated with each item;
(d) moving the items to a live auction when the countdown timer reaches sixty (60) minutes remaining;
(e) allowing the user to bid on items in a live auction;
(f) allowing the user to start a live auction for an item with a countdown timer displaying a time greater than one-hundred-twenty (120) minutes;
(g) only allowing the user to start one live auction during a one (1) hour time period;
(h) awarding the item to the highest bidder when the countdown timer reaches zero;
(i) resetting the countdown timer of an item to a predetermined amount, if the item has not been bid on;
(j) requiring the user to pay for the item within one hour of receiving the winning bid;
(k) if an item is not paid for within the one hour time period, the user is given a strike;
(l) the accumulation of three strikes by the user will result in the loss of bidding privileges; and
(m) shipping the item to the user with the winning bid after payment is processed.
